(19) United States
(12) Patent Application Publication
(10) Pub. No.: US 2016/0341298 A1
(43) Pub. Date: Nov. 24, 2016

(54) Transmission Oil Filter Assembly

(71) Applicant: Ford Global Technologies, LLC, Dearborn, MI (US)

(72) Inventors: Lev Pekarsky, W. Bloomfield, MI (US); Vladimir Yasnogorodskiy, Sterling Heights, MI (US); Akhter Zaman, Novi, MI (US); Mark Joseph Kane, Grosse Pointe Woods, MI (US)

(21) Appl. No.: 14/718,437

(22) Filed: May 21, 2015

(51) Int. Cl. F16H 57/04; B01D 35/147; B01D 35/30; B01D 29/96; B01D 35/00

(52) U.S. Cl. CPC F16H 57/0404; B01D 29/96; B01D 35/005; B01D 35/30; B01D 35/1475

(57) ABSTRACT

A transmission filter assembly utilizes a filter cartridge that slides axially with respect to the filter chamber. In normal operation, a spring pushes the filter cartridge into a position such that fluid flows into the interior of the cartridge, through filter media, and then radially out of the cartridge. If the pressure drop across the filter is excessive, the pressure forces the filter cartridge to slide to a position in which fluid bypasses the filter media. In this bypass mode, fluid does not flow into the interior of the cartridge and therefore has a very low tendency to dislodge previously captured contaminants. Two sets of tabs position the cartridge radially within the chamber. The two sets are separated axially to prevent tilting of the cartridge.

### TECHNICAL FIELD

This disclosure relates to the field of transmission systems. More particularly, the disclosure pertains to a filter assembly with improved pressure relief functionality.

### BACKGROUND

Automatic transmission fluid serves many functions in a modern automatic transmission. Pressurized fluid may be used engage friction clutches in order to establish a power flow path with a desired speed ratio. Fluid lubricates gears and bearings. Excess heat is removed by fluid flowing over various components. When the fluid contain contaminants, it may be less effective in these functions and may cause failures such as stuck valves. Therefore, transmissions often include fluid filters.

FIG. 1 is a cross section of a type of transmission filter 10. A housing 12 defines a filter chamber having an inlet port 14 and an outlet port 16. A filter cartridge 18 is located within the chamber. An inlet of the cartridge extends into inlet port 14 which positions the cartridge radially. The cartridge is positioned such that a flow path 20 is maintained between the exterior of the cartridge and the interior of the chamber. Seal 22 prevents fluid from flowing around the cartridge from the inlet port 14 to the outlet port 16. After the cartridge is inserted into the chamber, a cover 24 is attached to the housing. A seal 26 prevents fluid from leaking out of the chamber. A plurality of tabs 28 position the cartridge axially within the chamber. These tabs permit fluid to flow between a bottom surface of the cartridge and cover 24. Filter media 30 is positioned along a perforated side wall of the cartridge. The filter media may be, for example, pleated paper. Fluid flows from inlet port 14, through filter media 30 and the perforated side wall into flow path 20, and then out outlet port 16. Suspended contaminants 32, which do not fit through the filter media 30, are collected in the filter cartridge.

The filter media 30 provides some resistance to the flow. Consequently, the pressure at inlet port 14 must be greater than the pressure at outlet port 16 when fluid is flowing. The magnitude of this pressure difference depends upon the flow rate, the level of contamination in the filter media, and the fluid viscosity. When the temperature of the fluid is very cold, such as shortly after starting the vehicle during the winter, the viscosity can be very high causing the pressure drop across the filter to be excessive. When the pressure drop across the filter is excessive, relief valve 34 opens permitting fluid to bypass the filter media 30 to limit the pressure difference. Since contaminant usually enter the fluid only gradually, it is normally acceptable to periodically send unfiltered fluid to the outlet port. However, since the fluid passes close to the filter media on its way to the relief valve, some of the previously captured contaminant may re-enter the fluid. Consequently, the fluid leaving the outlet port 16 may actually have substantially more contamination than the fluid entering inlet port 14.

### SUMMARY OF THE DISCLOSURE

A transmission includes a hydraulic pump, a control system, a housing defining a filter chamber, a filter cartridge, and a spring biasing the filter cartridge toward a first position within the filter chamber. The pump draws fluid from a sump and supplies the fluid at increased pressure to a pump outlet circuit. The control system routes fluid from a line pressure circuit to transmission clutches. The filter chamber includes an inlet port connected to the pump outlet circuit and an outlet port connected to the line pressure circuit. When the filter is in the first position within the filter chamber, fluid is constrained to flow through filter media in the filter cartridge. If the pressure difference between the pump outlet circuit and the line pressure circuit exceeds a threshold, the filter cartridge slides within the filter chamber to a second position in which fluid may bypass the filter media. The transmission may also include a removable cover which provides access to replace the filter cartridge when the filter media is saturated with contaminants. In the first position, a face seal between the filter cartridge and the chamber may prevent bypass flow. Two sets of axially spaced tabs position the filter cartridge radially within the filter chamber while permitting circumferential flow around the cartridge.

A transmission oil filter includes a housing defining a filter chamber and a filter cartridge containing filter media configured to slide within the filter chamber. In a first position, fluid flowing from an inlet port to an outlet port of the chamber is constrained to flow through the filter media. In a second position, fluid may bypass the filter media. A spring may bias the filter cartridge toward the first position. For example, the spring may be a compression spring retained between the cartridge and a removable cover. A pressure difference between the inlet port and the outlet port may bias the cartridge toward the second position. Two sets of axially spaced tabs position the filter cartridge radially within the filter chamber while permitting circumferential flow around the cartridge.

An oil filter cartridge includes a perforated side wall, filter media, a bottom cap, and a top cap defining an inlet and having an exterior sealing surface. A plurality of tabs extend from each of the caps to locate the filter cartridge radially within a filter chamber while permitting the filter cartridge to slide axially with respect to the chamber. The bottom cap may be impervious to fluid flow at all pressure differences encountered in operation of a transmission, including at least 100 psi. The filter cartridge may also include a compression spring fixed to the bottom cap.

### BRIEF DESCRIPTION OF THE DRAWINGS

FIG. 1 is a cross section of a prior art transmission oil filter in a normal state.

FIG. 2 is a cross section of a prior art transmission oil filter in a bypass state.

FIG. 3 is a schematic of a transmission hydraulic system.

FIGS. 4 and 5 are cross sections of a transmission oil filter in a normal state.

FIG. 6 is a cross section of a transmission oil filter in a bypass state.

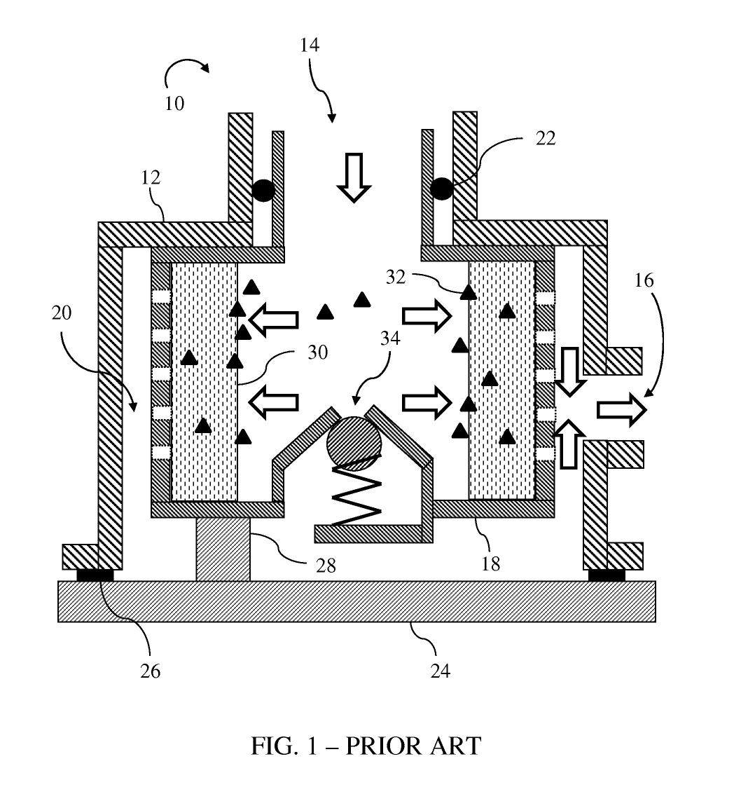

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

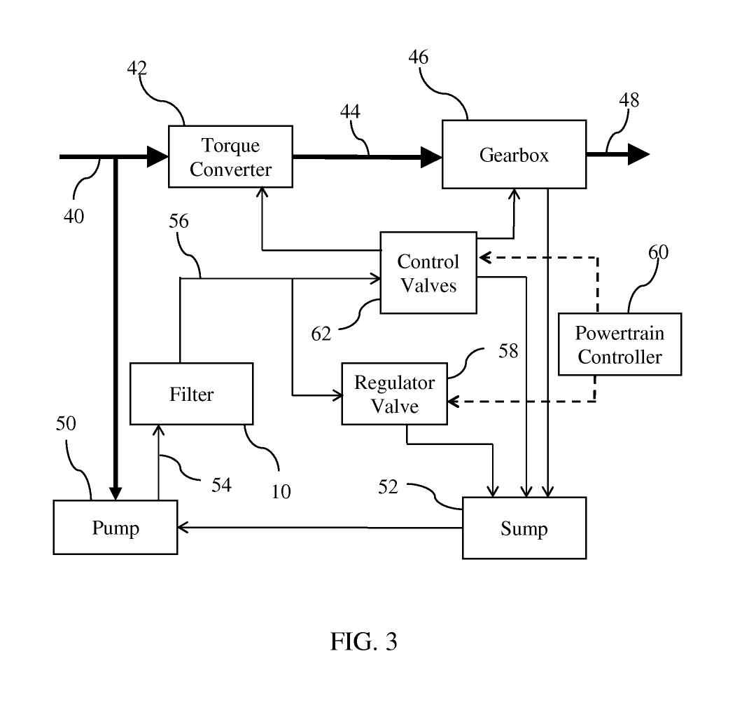

FIGS. 3 schematically illustrates a transmission hydraulic system. Bold lines indicate mechanical power flow. Solid lines indicate flow of hydraulic fluid. Dashed lines indicate electrical signals. Transmission input shaft 40 is connected to the vehicle crankshaft. Power from the engine is delivered to torque converter 42 which drives turbine shaft 44. Clutches within gearbox 46 are engaged to establish a power flow path from turbine shaft 44 to output shaft 48. Different power flow paths having different speed ratios may be established by engaging different clutches. Some engine power is diverted to drive transmission pump 50. Transmission pump 50 draws fluid from sump 52 and delivers the fluid, at increased pressure, to pump outlet circuit 54. The fluid flows from pump outlet circuit 54 through filter 10 into line pressure circuit 56. Regulator valve 58 releases some fluid back to sump 52 in order to maintain the pressure in the line pressure circuit at a desired level as commanded by controller 60. Controller 60 commands a network of control valves 62 to deliver fluid to torque converter and gearbox components at desired pressures less than line pressure and at desired flow rates. Fluid drains from the control valves and from the gearbox back into sump 52.

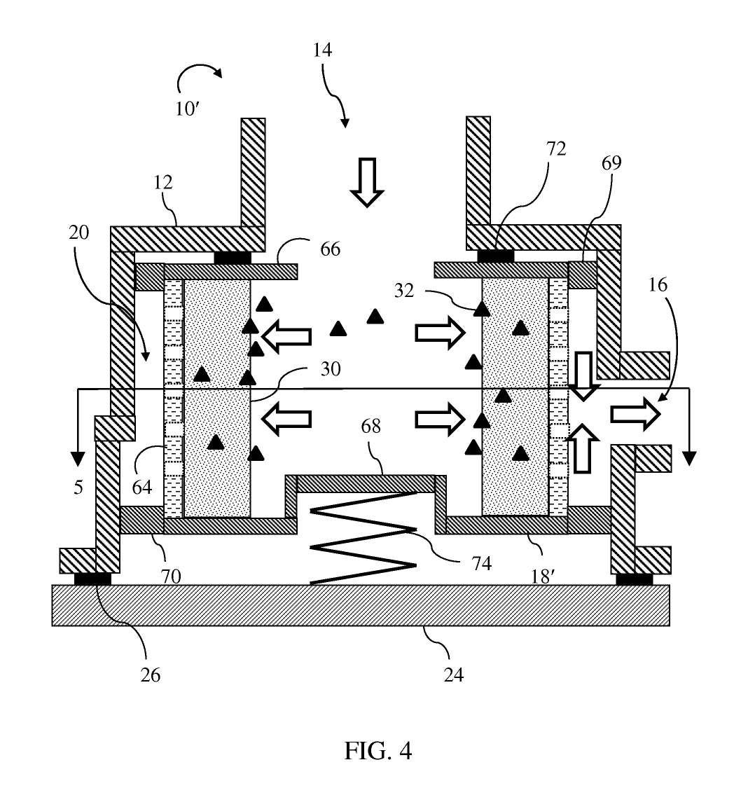

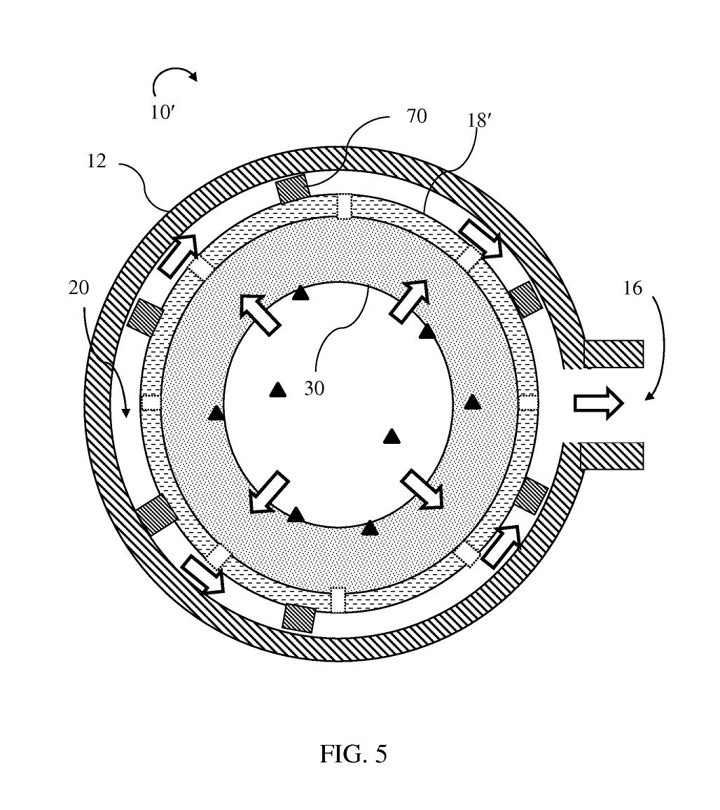

FIGS. 4 and 5 are cross sections of a transmission filter 10′. A housing 12 defines a filter chamber having an inlet port 14 and an outlet port 16. Due to the nature of the manufacturing process, such as casting, it may be necessary to form the chamber such that the diameter of the chamber is narrower near the top than near the base. (Although shown with a discrete step, the chamber may have a continuous taper.) A filter cartridge 18′ is located within the chamber. Filter cartridge 18′ includes a perforated, cylindrical side wall 64, a top cap 66, and a bottom cap 67. A plurality of tabs 69 on the top cap 66 and 70 on the bottom cap 68 position the cartridge radially such that a flow path 20 is maintained between the exterior of the cartridge and the interior of the chamber. To accommodate the taper or step of the chamber, the tabs on the bottom cap may extend further than the tabs on the top cap. In the condition shown in FIG. 4, face seal 72 prevents fluid from flowing around the cartridge from the inlet port 14 to the outlet port 16. Face seal 72 is made of compressible material that forms a seal when pressed against a flat surface. The quality of the seal would be degraded if the cartridge were to tilt within the chamber. Having two sets of tabs that are axially spaced apart from one another prevents the cartridge from tilting within the chamber. A cover 24 is attached to the housing. A seal 26 prevents fluid from leaking out of the chamber. Compression spring 74 between the bottom cap and cover 24 pushes the cartridge axially within the chamber toward the top of the chamber. Filter media 30 is positioned along the interior surface of the perforated side wall of the cartridge. The filter media may be, for example, pleated paper. Fluid flows from inlet port 14, through filter media 30 and the perforated side wall 64 into flow path 20, and then out outlet port 16. Suspended contaminants 32, which do not fit through the filter media 30, are collected in the filter cartridge. The terms top, bottom, and side indicate relative positions of components and do not indicate the orientation of the filter within the transmission.

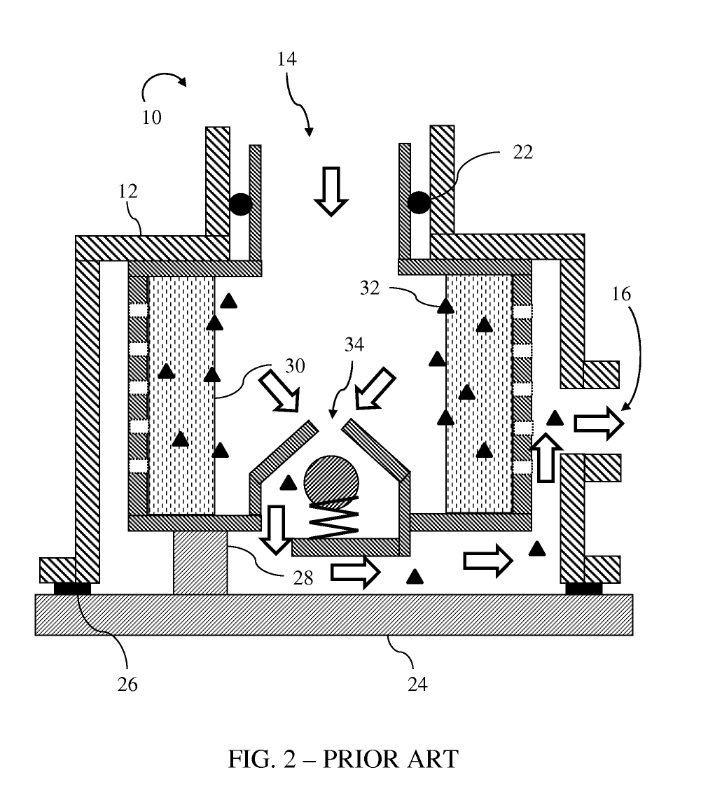

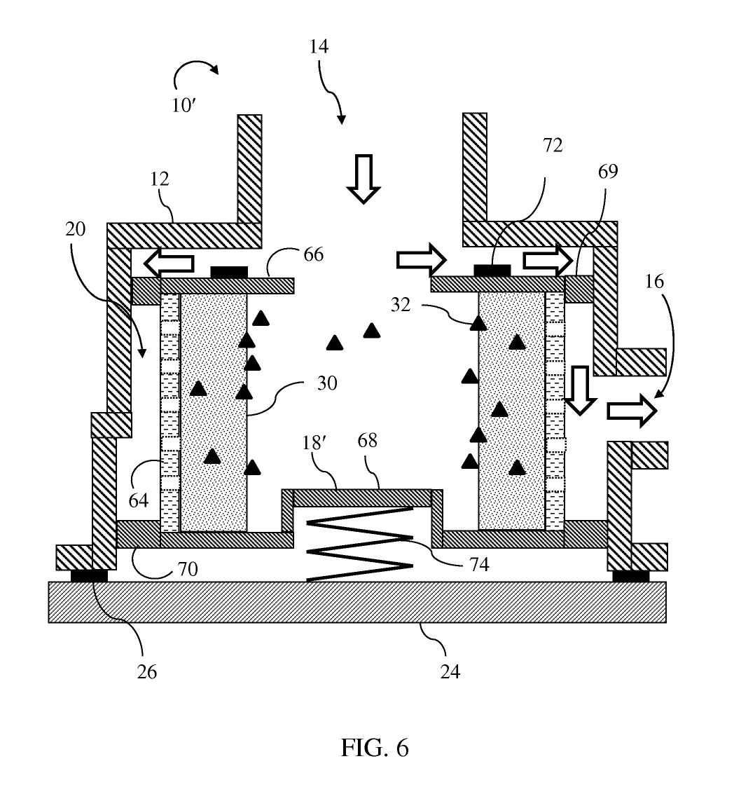

When fluid is flowing through the filter media, the pressure at inlet port 14 exceeds the pressure at outlet port 16. This differential pressure acts on an area equal to the area enclosed by face seal 72 tending to push the cartridge downward. During ordinary operation, the spring force exceeds the force generated by differential pressure and the cartridge remains in the position shown in FIG. 4. When the pressure drop is large, such as when temperature of the fluid is very cold, the pressure drop causes the cartridge to slide within the chamber to the position shown in FIG. 6. In this position, fluid flows radially out from inlet port 14 bypassing the filter media. Thus, pressure drop is limited. Unlike the circumstance illustrated in FIG. 2, the bypass flow does not pass over the filter media 30 where contaminants have accumulated. Therefore, there is no tendency for the previously collected contaminants to re-enter the fluid. Although FIG. 6 shows face seal 72 attached to cartridge 18′, it could also be attached to the inside of the chamber. Similarly, spring 74 may be fixed to cover 24 or fixed to cartridge 18′. The choice depends on whether it is desirable to replace these components when the filter cartridge is changed.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, embodiments described as less desirable than other embodiments or prior art implementations with respect to one or more characteristics are not outside the scope of the disclosure and can be desirable for particular applications.

What is claimed is:

1. A transmission comprising:
a hydraulic pump configured to draw fluid from a sump and supply the fluid at increased pressure to a pump outlet circuit;
a control system configured to route fluid from a line pressure circuit to a plurality of clutches;
a housing defining a filter chamber with an inlet port connected to the pump outlet circuit and an outlet port connected to the line pressure circuit;
a filter cartridge configured to slide within the filter chamber, the filter cartridge having two sets of tabs spaced axially away from one another and configured to position the filter cartridge radially within the filter chamber while permitting circumferential fluid flow between an exterior surface of the cartridge and an interior surface of the chamber, the filter cartridge containing filter media; and
a spring biasing the filter cartridge toward a first position with respect to the filter chamber in which fluid flow from the pump outlet circuit to the line pressure circuit is constrained to pass through the filter media, and wherein a pressure difference between the pump outlet circuit and the line pressure circuit biases the filter cartridge toward a second position in which fluid flow from the pump outlet circuit to the line pressure circuit bypasses the filter media.

2. The transmission of claim 1 further comprising a removable cover configured to provide access to replace the filter cartridge.

3. The transmission of claim 2 wherein the spring is a compression spring retained between the filter cartridge and the removable cover.

4. The transmission of claim 1 further comprising a compressible face seal configured to prevent bypass flow between the chamber and an exterior surface of the cartridge when the filter cartridge is in the first position.

5. The transmission of claim 1 wherein a first of the two sets of tabs has a first outer diameter and a second of the two sets of tabs has a second outer diameter greater than the first outer diameter.

6. A transmission oil filter comprising:
a housing defining a filter chamber having an inlet port and an outlet port; and
a filter cartridge containing filter media and having two sets of tabs spaced axially away from one another and configured to position the filter cartridge radially within the filter chamber while permitting circumferential fluid flow between an exterior surface of the cartridge and an interior surface of the chamber.

7. The transmission of claim 6 wherein the filter cartridge is configured to slide within the filter chamber between a first position in which fluid flow from the inlet port to the outlet port is constrained to pass through the filter media and a second position in which fluid flow from the inlet port to the outlet port bypasses the filter media.

8. The transmission oil filter of claim 7 further comprising a spring biasing the filter cartridge toward the first position.

9. The transmission oil filter of claim 8 further comprising a removable cover providing access to replace the filter cartridge.

10. The transmission oil filter of claim 9 wherein the spring is a compression spring retained between the filter cartridge and the removable cover.

11. The transmission oil filter of claim 7 wherein a pressure difference between the inlet port and the outlet port biases the filter cartridge toward the second position.

12. The transmission oil filter of claim 7 further comprising a compressible face seal configured to prevent bypass flow between the chamber and a top surface of the cartridge when the filter cartridge is in the first position.

13. The transmission of claim 7 wherein a first of the two sets of tabs has a first outer diameter and a second of the two sets of tabs has a second outer diameter greater than the first outer diameter.

14. An oil filter cartridge comprising:
a perforated side wall;
filter media adjacent to an interior surface of the side wall;
a bottom cap having a plurality of tabs configured to radially locate a bottom of the cartridge within a housing chamber; and
a top cap defining an inlet and having an exterior face sealing surface and a plurality of tabs configured to radially locate a top of the cartridge within the housing chamber.

15. The oil filter cartridge of claim 14 wherein the bottom cap is impervious to fluid flow at a pressure difference of 100 psi.

16. The oil filter cartridge of claim 14 wherein the face sealing surface is a surface of a compressible face seal fixed to the top cap around the inlet.

17. The oil filter cartridge of claim 14 further comprising a compression spring fixed to an exterior surface of the bottom cap.

18. The oil filter cartridge of claim 14 wherein:
the perforated side wall is cylindrical;
the tabs of the top cap have a first outer diameter; and
the tabs of the bottom cap have a second outer diameter greater than the first outer diameter.
